(19) United States
(12) Patent Application Publication
(10) Pub. No.: US 2012/0203738 A1
(43) Pub. Date: Aug. 9, 2012

(54) SYSTEM FOR IMPLEMENTING AND/OR EXPANDING A POINT-OF-SERVICE SYSTEM AND METHOD OF OPERATING THE SAME

(75) Inventors: Roland Aigner, Hallein/Rif (AT); Karl-Heinz Karpf, Kirchberg (AT)

(73) Assignee: quipos solutions GmbH, Wals-Siezenheim (AT)

(21) Appl. No.: 13/206,747

(22) Filed: Aug. 10, 2011

(30) Foreign Application Priority Data
Aug. 10, 2010 (EP) EP 10 172 350.0

(51) Int. Cl. G06F 17/30; H04W 84/02

(52) U.S. Cl. 707/634; 707/E17.005

(57) ABSTRACT

System (1) for implementing and/or expanding a point-of-service system comprising at least one central server (enabler) (2) and a plurality of handsets (3, 4, 5, 6, 7) configured to by connected to enabler (2) by wireless or by a network cable, said at least one enabler (2) comprising an interface to a database (8) of at least one point-of-service system (9) to be implemented or expanded, and said enabler (2) importing from database (8) of the point-of-service system to be implemented or expanded, passing on to handsets (3, 4, 5, 6, 7) and synchronising only those tables which are needed by handsets (3, 4, 5, 6, 7) for operating the point-of-service system or are entered by means of handsets (3, 4, 5, 6, 7), with the synchronisation intervals depending on the importance of such data, i.e. on the necessity of keeping the data available in database (8) of the point-of-service system to be implemented or expanded so as to ensure optimum operation thereof.

The present invention relates to a system for implementing and/or expanding a point-of-service system, as recited in the pre-characterizing portion of patent claim 1. The invention relates further to a method of implementing and/or expanding a point-of-service system, especially to a method of operating the inventive system.

Within the meaning of the present invention, a “point-of-service system” (POS system) is a computer-aided system by means of which end consumers take up an offer of a service; for example, POS systems are implemented in stadiums (for access control or beverage vending), trade fairs or in restaurants, as well as in hotels, clubs, resorts, wellness areas, beach areas, etc. (the “hospitality industry”), making possible functions such as “wireless order management ”.

For increased flexibility, it is advantageous for a POS system to ensure mobility as comprehensive as possible.

As a rule, POS systems of this nature comprise mobile terminals (handsets) coupled to a central server; in this context the use as handsets of PDA devices has been known, which increase the complexity of the system in its entirety, however. For these reasons, the maximum number of PDA devices which may be integrated in the system is limited.

Also known are POS systems configured as open systems in which are provided handsets (“handhelds”) designed to be controlled by a central computer. Solutions of this nature are based on a “thin client-server” architecture in which the handsets serve as “remote control units” of a central computer. These systems are disadvantageous in that they cannot be expanded by interfaces, which may be needed in stadium settings, for example, to enable a variety of different services to be offered within one and the same system.

Also known are self-contained POS systems which use handsets designed to achieve a single purpose; such POS systems are suited for restaurants almost exclusively and cannot be expanded as needed.

Further, it has been known from prior art to use tablet-PCs for communications with a central server. The size and weight of the tablet-PCs used as handsets compromise the flexibility and the ergonomy of the system, however.

The object underlying the present invention is to provide a system for implementing and/or expanding a POS system which offers enhanced flexibility and is suited for use as a mobile solution.

Further, the inventive system seeks to ensure that it may be readily set up and put into service, is easily individualised and ensures data communications that are safe and protected from manipulation.

This way, a POS system is to be implemented, and existing POS systems are to be expanded, in a simple and cost-effective way.

Another object of the present invention is a method of implementing and/or expanding a POS system and, especially, a method of operating an inventive system for the implementation and/or expansion of a POS system.

This object is achieved by the features recited in patent claim 1. A method of implementing and/or expanding a POS system, and especially a method of operating the inventive system, is the subject matter of claim 9. Inventive further developments and advantages are shown in the respective dependent claims.

Accordingly, there is proposed a system for implementing and/or expanding a POS system comprising at least one central server (referred to a “enabler” hereinafter) and a plurality of handsets adapted to be connected with the enabler by wireless or a network cable, with said at least one enabler including an interface to a database of at least one POS system to be implemented or expanded, respectively, and the enabler importing from the database of the POS system to be implemented or expanded, passing on to the handsets and synchronizing only those data or tables which are relevant to the operation of the POS system; advantageously, data stored in the database of the POS system which are irrelevant to the operation of that system—such as customer addresses and statistics—are not imported by the enabler and are not synchronized either. The handsets serve to get the POS system to interact with the end consumers.

Particularly, the enabler passes on to the handsets from the database of the POS system to be implemented or expanded and synchronises only those tables which are needed by the handsets for operating the POS system or are entered by said handsets.

Thus the at least one enabler connects the system for implementing and/or expanding a POS system with the database of the POS system to be implemented and/or expanded, with the enabler serving also to synchronize the data between the handsets (adapted to be connected by wireless with the enabler) and the database of the POS system to be implemented or expanded.

Advantageously, the enabler is configured to be a scalable computer or server so as to enable the overall system to meet a variety of different requirements.

In this respect, the at least one enabler may comprise a plurality of interfaces to a plurality of databases each associated with a POS system to be implemented and/or expanded. For example, it is possible at the beginning of an event to use the database of an access control system, to use the handsets to control access by evaluating access privileges and to use the enabler to synchronize the corresponding data with the database of the access control system; thereafter, the data base of an “in-seat” catering system may be used to offer services such as the feeding of the guests of the event.

It is possible also to simultaneously connect the enabler to a plurality of databases each corresponding to a different POS system, with the handsets distributed among the POS systems or with the operator of a handset switching it over as needed between the various POS systems.

Connections between the at least one enabler and the POS system database may be by wireless, by wire within a network or via the internet, for example.

The inventive concept allows a single end system—comprising at least one enabler and a plurality of handsets associated therewith—to ensure connections with at least one database of a POS system. This reduces both the complexity and the cost of implementing or expanding a POS system.

The handsets provided in accordance with the invention comprise a central processing unit (CPU), memory as well as an operating system and display means—preferably in form of a touchscreen—for entering relevant data. The handsets are adapted to be connected with the at least one enabler by wireless or a network cable, with the enabler managing the data transferred—or to be transferred—to each handset. Specifically, it is only the data or tables needed for operating a POS system which are passed on from the database of the POS system to be implemented or expanded to the associated handsets, with the enabler handling the synchronisation of such data with the database of the respective POS system.

In the case of a POS system for access control, for example, of which the database comprises hundreds of database tables, only four data per end consumer are needed in a table (User_ID, Event_ID, Seat/sector, Access/No_Access), with a single item only (Access/No_Access) to be synchronized with the POS system database.

Synchronization of the data entered via the handsets—e.g. the item “Access/No_Access” in an access control POS system—with the database of the POS system to be implemented or expanded is effected by the enabler, with the dynamics of such synchronisation (i.e. the synchronisation intervals) being dependent on the importance of such data, i.e. the necessity of keeping them available in the database of the POS system to be implemented or expanded for the optimal operation of said system.

In a POS system designed for access control, for example, synchronisation may take place every five minutes but much more often in a POS system for the hospitality industry. For reducing the amount of data to be transferred during POS system operation, it may be provided advantageously that data not needed for actual system operation—such as data regarding merchandising items sold in a stadium—are not synchronized for end consumers before the end of the POS system operation. Until they are synchronized, such data are committed to intermediate storage in the respective handset or in the enabler.

In accordance with the invention, the system handsets are designed to be modular in construction so as to meet the requirements of different POS systems. For example, the handsets may comprise an RFID or NFC module for reading access privileges, a one- or two-dimensional barcode module, a Bluetooth module for communication with printers and/or signaling devices, a USB port, a magnetic card reader and/or at least one biometry reader.

The various modules are advantageously disposed—or designed to be disposed —in the bottom housing shell of the handsets so that appropriate modules may be made available by changing the bottom housing shell to meet the requirements a POS system must satisfy. For example, an RFID or NFC module and/or a magnetic card reader may be provided for implementing and/or expanding an access-control POS system.

Connections of the handsets of the system to the enabler are effected preferably via a wireless infrastructure—configured as a WLAN and/or GPRS/3G infrastructure—under management by the enabler. It is possible also to use as a wireless infrastructure one which operates in an ISM band or, alternatively, uses a frequency in any other suitable frequency band.

In case a WLAN infrastructure is used, there are provided access points operating preferably under the Linux open-source operating system, with the access points integrating an administrative interface making management and control by the enabler possible.

In the case of a GPRS/3G wireless infrastructure, it is proposed in accordance with the invention to operate a so-called match-making server, which makes possible a routing of the handset to an enabler via the internet. In the process, the handset registers on the match-making server and, when registering, advises the match-maker of an identification; if the identification is valid, the match-making server passes the internet address of the respective enabler on to the handsets so that these may communicate directly with the enabler.

Alternatively, the handsets may communicate with the enabler via a specialised enabler (“super-enabler”) which may be called up in the internet to route data to an enabler in a locally installed POS system.

The software environment of the handsets preferably comprises a Linux operating system including an application interface such as an Android 2.X interface, for example, which offers all the advantages of a high performance embedded development and those of a fully performing operating system, with the application layer being very stable.

In accordance with the invention, application development aimed at some handset is effected by modifying for a specific set of tasks masks existing in a GUI designer and to combine them to form a workflow. In certain applications, it may be necessary to make simple data manipulation possible at the handset directly, which would call for the integration of a script engine in the handset at issue.

In accordance with the invention, the enabler is coupled via a database and applications interface to the database of the POS system to be implemented or expanded, with the database synchronisation intervals and additional parameters set via the database and applications interface and via an “Enabler Configuration Service” module installed in the enabler. In accordance with the invention, the enabler includes a synchronizing engine which assumes data synchronisation between the handsets and the POS system database.

Further, the enabler includes a “Settings Database” for managing the synchronisation intervals set via the Enabler Configuration Service, as well as the settings of the associated handsets. This way, a handset is easily replaced, with the settings it requires restored in analogy to a back-up/restore scenario.

In accordance with the invention, the enabler includes a “Device Database” for managing the associated handsets, the wireless infrastructure and the locating of handsets in a GPRS/3G infrastructure. Also, the Device Database stores security tokens, firmware and scripts to ensure availability in the case of update or replacement.

The scripts needed for data display and manipulation are stored in the Device Database the same way as user data, whereby the mechanisms described above ensure that these scripts are kept synchronous inside the system.

Further, the enabler includes an “Internal Database” which stores security-relevant data and settings such as hashes of keys, licenses for handset usage and special synchronisation settings.

The inventive concept provides a complete mobile solution for implementing and/or expanding a POS system which offers enhances possibilities of individualisation and maximum flexibility. The at least one enabler being scalable, it is possible to implement or expand POS systems suited for events of any size.

Within the framework of the inventive method of implementing and/or expanding a POS system, at least one central server (enabler) may be used to set up by wireless a connection to a database of at least one POS system to be implemented or expanded, using a plurality of handsets each incorporating a CPU, memory and an operating system as well as a display in the form of a touchscreen. As explained above, the enabler merely imports, passes on to the handsets and synchronises the database tables needed for operating the POS system or entered at the handsets, with the synchronisation intervals advantageously dependent on data importance, i.e. the necessity of maintaining the data available in the database of the POS system to be implemented or expanded to ensure an optimum operation thereof. Data transferred or to be transferred to each handset are handled and managed by the enabler.

In what follows, the invention is illustrated in greater detail under reference to the attached figures.

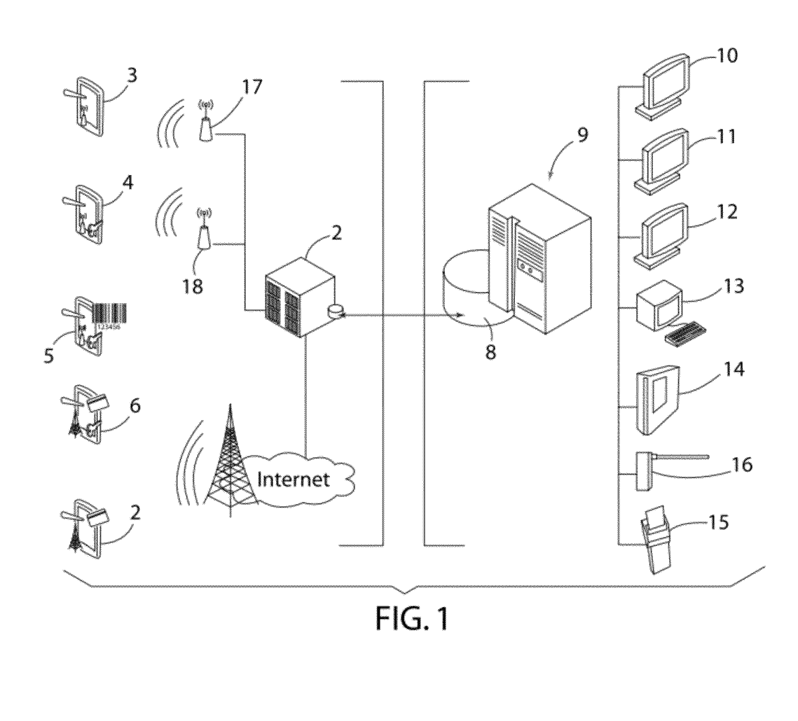

FIG. 1 shows an overview of an inventive system for implementing and/or expanding a POS system;

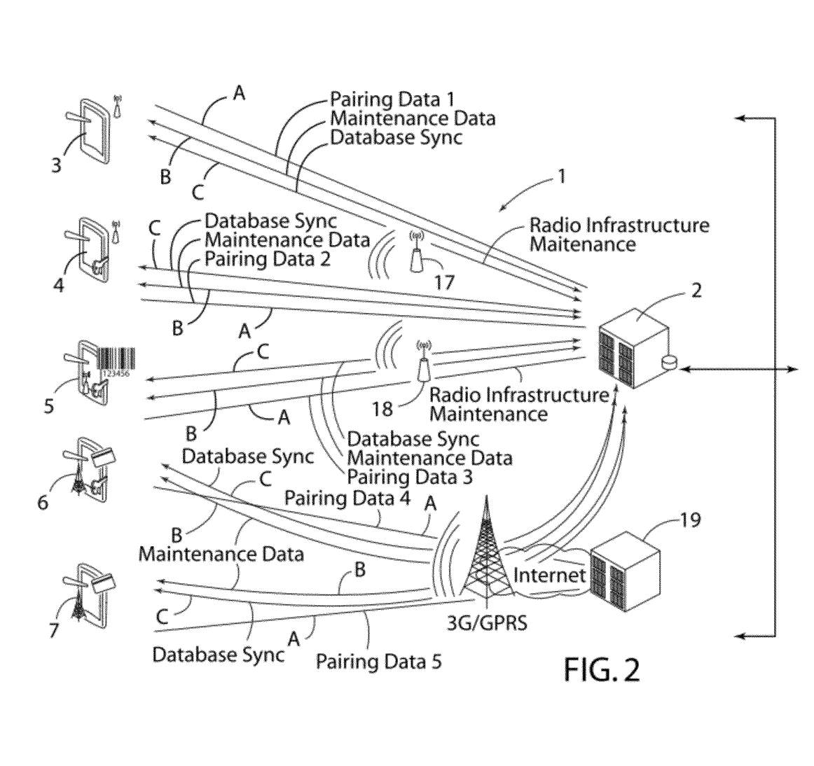

FIG. 2 shows an inventive system for implementing and/or expanding a POS system and illustrates possibilities of integrating handsets into the overall system;

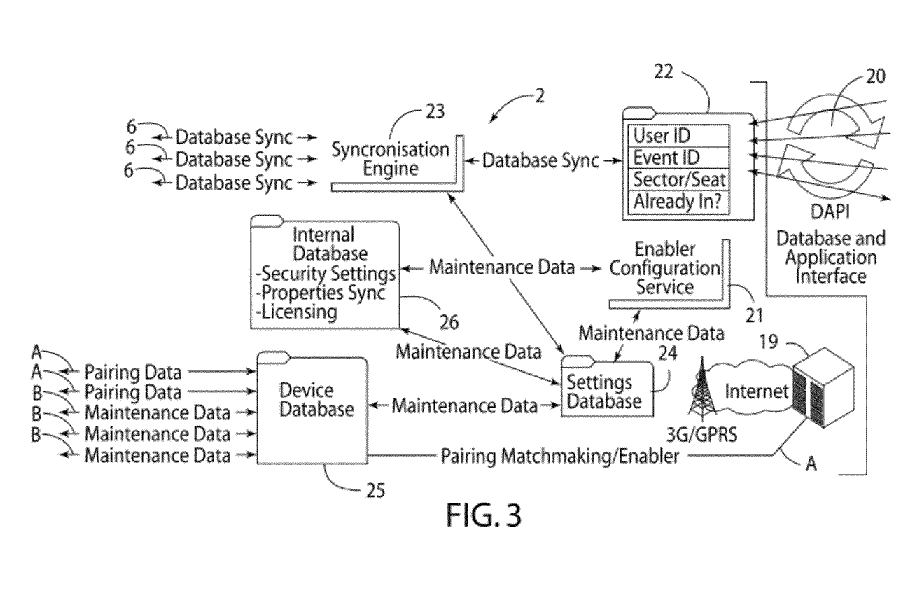

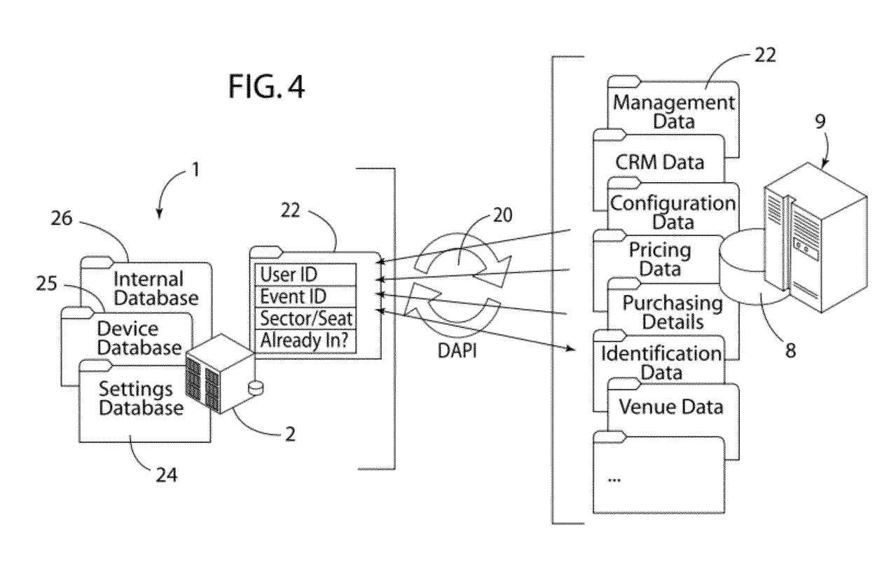

FIG. 3 shows the internal structure of an inventive enabler; and FIG. 4 shows the data to be imported in accordance with the invention from the database of the POS system to be implemented or expanded for the case of a POS system used for access control, illustrating the small amount of data to be transferred to the inventive system.

In accordance with the invention, and under reference to FIG. 1, a system 1 for implementing and/or expanding a POS system comprises at least one enabler 2 and a plurality of handsets 3, 4, 5, 6, 7 adapted to be coupled by wireless with enabler 2, said at least one enabler 2 including an interface to a database 8 of at least one POS system 9 to be implemented or expanded. Alternatively, the handsets (several or all of them) may be configured to be coupled to the enabler via a network cable—e.g. in case the infrastructure in a stadium makes it possible at the beginning of a match to hang handsets up and connect them to a network cable at an assigned location and to take them down after the match. These handsets may serve as “self-ordering terminals”, for example.

As shown in FIG. 1, the point-of-service system 9 to be expanded may comprise at least one point-of-sale terminal 10 at a hotel reception desk, at least one point-of-sale terminal 11 in a restaurant, at least one point-of-sale terminal 12 in a retail outlet, a back-office infrastructure 13 as well as access control devices 14, 15, 16 for persons or vehicles, which correspond to an existing POS system to be expanded.

In the case of a POS system 9 to be implemented, the only database 8 used is that which is connected with enabler 2.

Connections of handsets 3, 4, 5, 6, 7 of the system with enabler 2 are effected preferably via WLAN and/or GPRS/3G under management by enabler 2. In FIG. 1, the access points needed to ensure a WLAN link are marked with reference numerals 17 and 18. Connections of handsets 3, 4, 5 with enabler 2 are run via these access points 17, 18; handsets 3, 4, 5 may be configured to form the mobile terminals of a POS system in a hotel, a restaurant or a stadium. For illustrating the invention, FIG. 1 shows two more handsets 6, 7 intended for use as handsets of a POS system in a beach area or on a golf course. These handsets 6, 7 may preferably be connected to enabler 2 via a GRPS/3G link to the internet.

In the case of a GPRS/3G link between handsets 6, 7 and enabler 2, it is proposed (see FIG. 2) to operate a match-making server which enables a handset 6 or 7 to be routed to enabler 2 via the internet. In the example depicted in FIG. 2, three connecting lines A, B and C are shown between enabler 2 and handsets 3, 4, 5 to be connected with enabler 2 via a WLAN, with line A representing the connection between one handset and enabler 2 for registering that handset at the enabler, line B representing the connection between a handset and enabler 2 for the transfer of settings or maintenance/service data and line C representing the connection of a handset to enabler 2 for data transfer to synchronise the data with the database of the POS system 9 to be implemented or expanded.

As shown in FIG. 2, line A runs between handsets 6, 7 and match-making server 19 in case a GPRS/3G link exists between handsets 6, 7 and enabler 2; lines B and C run between handsets 6, 7 and enabler 2.

FIG. 3 illustrates the internal structure of an inventive enabler 2. As shown in FIG. 3, enabler 2 comprises a database and application interface (DAPI) 20 connecting it with database 8 of the POS system to be implemented or expanded, with the setting of the database synchronising intervals and of further enabler or system parameters effected via the database and application interface 20 and via an “Enabler Configuration Service” module 21. In FIG. 3, reference numeral 22 is used to designate an exemplary table holding the data to be synchronised between the inventive system and the database of the POS system to be implemented or expanded.

As shown in FIG. 3, enabler 2 includes a Synchronisation Engine 23 which assumes the synchronisation of data between the handsets and the database of the POS system; accordingly, lines C correspond to the lines C shown in FIG. 2. The underlying method of synchronisation is shown in FIG. 4.

Reference 24 designates a “Settings Database” used to manage the synchronising intervals set via Enabler Configuration Service module 21 and the settings of the associated handsets and of the enabler or the inventive system. For example, the data stored in the settings database allow a handset in the system to be replaced easily, with the handset settings restored in analogy to a back-up/restore scenario.

Accordingly, Setting Database 24 is connected with the Enabler Configuration Service module 21 and with Synchronisation Engine 23 for the transfer of setting data.

Further, the enabler comprises a “Device Database” 25 designed to manage the handsets registered at the enabler, the wireless infrastructure and the locating of handsets within a GPRS/3G infrastructure. Moreover, the Device Database stores security tokens, firmware and scripts to ensure availability in the event of update or replacement; for the transfer of settings, Device Database 25 is connected with Settings Database 24. In case handsets are connected with enabler 2 via a GPRS/3G link and a match-making server 19, Device Database 25 is connected with match-making server 19 for the transfer of required data (see lines A in FIG. 2). In case the handsets are connected with enabler 2 via a WLAN, they are connected with Device Database 25 for the transfer of the connection data required therefor (see lines A in FIG. 2). Further, the handsets are connected with Device Database 25 for the transfer of settings or of maintenance/service data (see lines B in FIG. 2).

For the storage of security-relevant data and settings—such as the hashes of keys, of licenses for handset usage and of special synchronisation settings, enabler 2 comprises an “Internal Database” 26, which is connected with Settings Database 24 and with the Enabler Configuration Service module 21 for the transfer of the required data. In accordance with the invention, the scripts needed for user management may be organised in the Internal Database 26 of the enabler and may be synchronised like the data of database 8.

0057) FIG. 4 illustrates the inventive database synchronisation. The lefthand portion of that Figure schematically shows an inventive system 1 connected via a database and application interface (DAPI) 20 with database 8 of the POS system 9 to be implemented or expanded. In accordance with the invention, the only data or tables from database 9 of the POS system to be implemented or expanded which are imported by means of the handsets connected to enabler 2, are passed on to the handsets and are synchronised are those that are relevant to the operation of the POS system; advantageously, enabler 2 neither imports nor synchronises data in the POS system database which are not relevant to the operation thereof, such as customer addresses, statistics, administrative data, prices and turn-over data.

0058) This case is shown in FIG. 4 for a POS system for access control in a stadium of which the database comprises a major number of database tables 27. In accordance with the invention, operation of the access control POS system using handsets connected to enabler 2 requires in a table only four data items per end consumer, i.e. per paying spectator, namely, User_ID, Event_ID, Seat/Sector and Access/No_Access, with the only item to be synchronised with the POS system database being Access/No_Access.

0059) Synchronisation of the data entered via the handsets—e.g. the item Access/No_Access for the case of an access control POS system—with those in database 8 of the POS system 9 to be implemented or expanded is handled by enabler 2, with the dynamics of such synchronisation dependent on the importance of the data, as explained above.

The inventive concept results in the provision of a system suited to be integrated as a complete mobile solution into existing POS systems to expand them while maintaining maximum flexibility; further, implementation of a POS system calls only for a database provided by the POS system operator, to which database the inventive system is connected. An additional advantage for the POS system operator is the possibility of resorting to a complete mobile solution without having to put up with development risks; in addition, the system components—and particularly the handsets—may be promoted under a brand name of their own, making product line expansion possible in a simple manner.

0061) The inventive system is suited for use as access control for persons and/or vehicles, for the wireless management of orders in the hospitality industry, for the vending of articles and for offering services in general.

1. A system (1) for implementing and/or expanding a point-of-service system, characterized by comprising at least one central server (enabler) (2) and a plurality of handsets (3, 4, 5, 6, 7) adapted to be connected with enabler (2) by wireless or by a network cable, said at least one enabler (2) including an interface to a database (8) of at least one point-of-service system (9) to be implemented or expanded, said at least one enabler (2) importing, passing on to handsets (3, 4, 5, 6, 7) and synchronising from database (8) of the point-of-service system (9) to be implemented or expanded those tables only which are needed by handsets (3, 4, 5, 6, 7)—or are entered by means of handsets (3, 4, 5, 6, 7)—for operating said point-of-service system, and with the synchronisation intervals being dependent on data importance, i.e. the necessity of maintaining the availability of the data in database (8) of the point-of-service system to be implemented or expanded so as to ensure the optimum thereof.

2. System (1) for implementing and/or expanding a point-of-service system as claimed in claim 1, characterized in that the at least one enabler (2) may include a plurality of interfaces to different databases each associated with a point-of-service system to be implemented or expanded.

3. System (1) for implementing and/or expanding a point-of-service system as claimed in claim 2, characterized in that enabler (2) is connected simultaneously to a plurality of databases each corresponding to different point-of-service systems, with handsets (3, 4, 5, 6, 7) distributed among said point-of-service systems or the operator of a respective handset (3, 4, 5, 6, 7) being free to switch over among the different point-of-service systems as needed.

4. System (1) for implementing and/or expanding a point-of-service system as claimed in claim 1, characterized in that handsets (3, 4, 5, 6, 7) comprise a CPU, memory and an operating system as well as display means in the form of a touchscreen, with the data transferred or to be transferred to each handset handled and organised by enabler (2).

5. System (1) for implementing and/or expanding a point-of-service system as claimed in claim 4, characterized in that handsets (3, 4, 5, 6, 7) are configured to be modular in construction so as to meet the requirements of different point-of-service systems and comprise an RFID or NFC module for reading access privileges, a one-or two-dimensional barcode module, a Bluetooth module for communication with printers and/or signaling devices, an USB port, a magnetic card reader and/or at least one biometry sensor.

6. System (1) for implementing and/or expanding a point-of-service system as claimed in claim 5, characterized in that the various modules are disposed or adapted to be disposed in the lower housing shell of handsets (3, 4, 5, 6, 7) so that, by correspondingly changing the lower housing shells, modules may be made available in accordance with the requirements the point-of-service systems must meet.

7. System (1) for implementing and/or expanding a point-of-service system as claimed in claim 1, characterized in that the connections of handsets (3, 4, 5, 6, 7) with enabler (2) are effected via a wireless infrastructure under management by enabler (2), said wireless infrastructure configured to operate under WLAN and/or GPRS/3G standards, and in that, in the case of a GPRS/3G wireless infrastructure, there is provided either a match-making server (19) making possible the routing of handsets (6, 7) to an enabler (2) via the internet, or a specialised enabler configured to be called up in the internet to route the data to an enabler (2) of a point-of-service system.

8. System (1) for implementing and/or expanding a point-of-service system as claimed in claim 1, characterized in that enabler (2) comprises the following components:
a Database and Application Interface (DAPI) (20) via which said enabler (2) is connected with database (8) of the point-of-service system (9) to be implemented or expanded, with the setting of the synchronisation intervals of said database and of additional parameters of enabler (2) or system (1) being effected via database and application interface (20) and an Enabler Configuration Service module (21) installed within enabler (2);
a Synchronisation Engine (23) which assumes the synchronisation of data between handsets (3, 4, 5, 6, 7) and database (8) of point-of-service system (9);
a Settings Database (24) via which are managed the synchronisation intervals set via the Enabler Configuration Service module (21) and the settings of the associated handsets and of enabler (2) or system (1);
a Device Database (25) via which are managed the handsets registered at enabler (2), the wireless infrastructure and the finding of handsets within a GPRS/3G infrastructure, with the Device Database (25) storing security tokens, firmware and scripts to ensure availability in the case of updates/replacement; and
an Internal Database (26) for storing security-relevant data and settings such as the hashes of keys, licenses for handset usage and specialised synchronisation setting, with the scripts needed for user prompting handled and managed in Internal Database (26) of said enabler and being synchronised like the data in database (8).

9. A method of implementing and/or expanding a point-of-service system, characterized in that a connection to a database (8) of at least one point-of-service system (9) to be implemented or expanded is set up by means of at least one central server (enabler) (2) to which a plurality of handsets (3, 4,5, 6, 7) each comprising a CPU, memory as well as an operating system and display means in the form of a touchscreen may be connected by wireless or by a network cable, in that enabler (2) imports, passes on to handsets (3, 4, 5, 6, 7) and synchronises only those tables from database (8) which handsets (3, 4, 5, 6, 7) need for operating the point-of-service system or are entered by means of handsets (3, 4, 5, 6, 7), in that the synchronisation intervals are dependent on the importance of the data in database (8) of the point-of-service system (9) to be implemented or expanded, i.e. on the necessity of maintaining the availability of such data so as to ensure an optimum operation of said point-of-service system, and in that the data transferred or to be transferred to each handset (3, 4, 5, 6, 7) are handled and managed by enabler (2), with handsets (3, 4, 5, 6, 7) serving to effect the interaction of said point-of-service system with the end consumers.

10. Method of implementing and/or expanding a point-of-service system as claimed in claim 9, characterized by simultaneously or sequentially connecting the at least one enabler (2) via interfaces with different databases each associated with one point-of-service system to be implemented or expanded, said handsets (3, 4, 5, 6, 7) distributed among said different point-of-service systems or with the operator of a handset (3, 4, 5, 6, 7) switching over as needed between the different point-of-service systems.

11. Method of implementing and/or expanding a point-of-service system as claimed in claim 9, characterized by handsets (3, 4, 5, 6, 7) being configured to be modular in structure so as to enable them to meet the requirements of different point-of-service systems and by providing the corresponding modules by changing the lower handset shells housing said modules.

12. Method for implementing and/or expanding a point-of-service system as claimed in claim 9, characterized by connecting handsets (3, 4, 5, 6, 7) with enabler (2) via a network cable or via a wireless infrastructure managed by enabler (2) which may be organised as a WLAN and/or GPRS/3G infrastructure, and by providing in the case of a GPRS/3G wireless infrastructure either a match-making server (19) via which handsets (6, 7) may be routed to an enabler (2) via the internet, or a specialised enabler available to be called up in the internet to route the data to an enabler (2) of a point-of-service system.

13. Method for implementing and/or expanding a point-of-service system as claimed in claim 9, characterized in that it is executed to operate a system.

14. The use of a system as claimed in claim 1, for implementing and/or expanding a point-of-service system for the access control of persons and/or vehicles, for the wireless order management in the hospitality industry, for the vending of articles and for the offering of services.
